(19) United States
(12) Patent Application Publication
(10) Pub. No.: US 2014/0198059 A1
(43) Pub. Date: Jul. 17, 2014

(54) ELECTRONIC DEVICE WITH TOUCH-SENSITIVE DISPLAY AND GESTURE-DETECTION

(71) Applicant: RESEARCH IN MOTION LIMITED, Waterloo (CA)

(72) Inventors: Huanhuan GU, Kitchener (CA); Tongyan ZHAI, Buffalo Grove, IL (US); Dan TOCILA, Lakemoor, IL (US); James Paul WARDEN, Forth Worth, TX (US); Arnold SHEYNMAN, Northbrook, IL (US)

(73) Assignee: RESEARCH IN MOTION LIMITED, Waterloo (CA)

(21) Appl. No.: 13/743,261

(22) Filed: Jan. 16, 2013

(51) Int. Cl. G06F 3/041

(52) U.S. Cl. CPC G06F 3/041
USPC 345/173

(57) ABSTRACT

A method includes utilizing transmitters and receivers in an electronic device to detect at least one object spaced from a touch-sensitive display of the electronic device, determining first signal values utilizing touch sensors of the touch-sensitive display to obtain baseline noise values when no touch is detected and the transmitters are transmitting, and when a touch is detected, applying the baseline noise values to second signal values to reduce the effect of noise when identifying the touch location.

### FIELD OF TECHNOLOGY

The present disclosure relates to electronic devices, including but not limited to, portable electronic devices having touch-sensitive displays and their control.

### BACKGROUND

Electronic devices, including portable electronic devices, have gained widespread use and may provide a variety of functions including, for example, telephonic, electronic messaging and other personal information manager (PIM) application functions. Portable electronic devices include, for example, several types of mobile stations such as simple cellular telephones, smart phones, wireless personal digital assistants (PDAs), and laptop computers with wireless 802.11 or Bluetooth capabilities.

Portable electronic devices such as PDAs or smart telephones are generally intended for handheld use and ease of portability. Smaller devices are generally desirable for portability. A touch-sensitive display, also known as a touchscreen display, is particularly useful on handheld devices, which are small and have limited space for user input and output. The information displayed on the touch-sensitive displays may be modified depending on the functions and operations being performed. With continued demand for decreased size of portable electronic devices, touch-sensitive displays continue to decrease in size.

Improvements in devices with touch-sensitive displays are desirable.

### BRIEF DESCRIPTION OF THE DRAWINGS

FIG. 1 is a block diagram of an electronic device in accordance with the disclosure.

FIG. 2 is a front view of an example of a touch-sensitive display of an electronic device in accordance with the disclosure.

FIG. 3 is a side view of an electronic device in accordance with the disclosure.

FIG. 4 is a flowchart illustrating a method of detecting touches on a touch-sensitive display in accordance with the disclosure.

FIG. 5 is a front view of another example of a touch-sensitive display of an electronic device in accordance with the disclosure.

### DETAILED DESCRIPTION

The following describes an electronic device and a method that includes utilizing transmitters and receivers to detect an object or objects that are spaced from a touch-sensitive display of the electronic device. Baseline values are obtained based on signal values determined when a touch is not detected on the touch-sensitive display. The baseline noise values are applied to signal values detected when a touch is detected, to reduce the effect of noise on the signal values when identifying the touch location.

For simplicity and clarity of illustration, reference numerals may be repeated among the figures to indicate corresponding or analogous elements. Numerous details are set forth to provide an understanding of the examples described herein. The examples may be practiced without these details. In other instances, well-known methods, procedures, and components are not described in detail to avoid obscuring the examples described. The description is not to be considered as limited to the scope of the examples described herein.

The disclosure generally relates to an electronic device, such as a portable electronic device or non-portable electronic device. Examples of portable electronic devices include mobile, or handheld, wireless communication devices such as pagers, cellular phones, cellular smart-phones, wireless organizers, personal digital assistants, wirelessly enabled notebook computers, tablet computers, mobile internet devices, electronic navigation devices, and so forth. The portable electronic device may be a portable electronic device without wireless communication capabilities, such as handheld electronic games, digital photograph albums, digital cameras, media players, e-book readers, and so forth. Examples of non-portable electronic devices include desktop computers, electronic white boards, smart boards utilized for collaboration, built-in monitors or displays in furniture or appliances, and so forth.

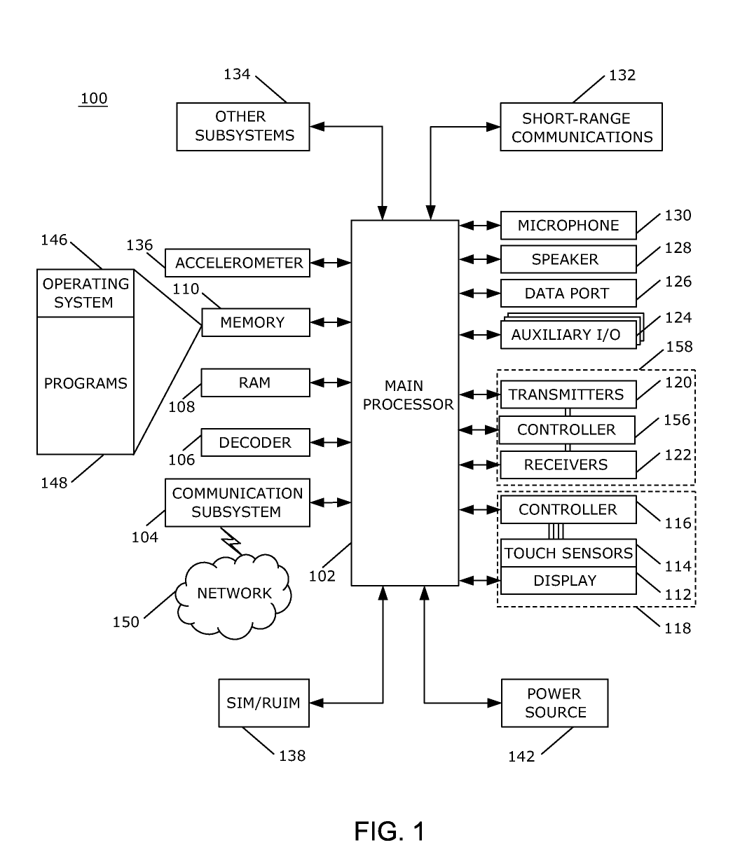

A block diagram of an example of an electronic device 100 is shown in FIG. 1. The electronic device 100 includes multiple components, such as a processor 102 that controls the overall operation of the electronic device 100. Communication functions, including data and voice communications, are performed through a communication subsystem 104. Data received by the electronic device 100 is decompressed and decrypted by a decoder 106. The communication subsystem 104 receives messages from and sends messages to a wireless network 150. The wireless network 150 may be any type of wireless network, including, but not limited to, data wireless networks, voice wireless networks, and networks that support both voice and data communications. A power source 142, such as one or more rechargeable batteries or a port to an external power supply, powers the electronic device 100.

The processor 102 interacts with other components, such as a Random Access Memory (RAM) 108, memory 110, a touch-sensitive display 118, a 3D gesture detector 158, an auxiliary input/output (I/O) subsystem 124, a data port 126, a speaker 128, a microphone 130, short-range communications 132 and other device subsystems 134. The touch-sensitive display 118 includes a display 112 and touch sensors 114 that are coupled to at least one controller 116 that is utilized to interact with the processor 102. The three-dimensional gesture detector 158 includes transmitters 120 and receivers 122 that are coupled to a controller 156. Input via a graphical user interface is provided via the touch-sensitive display 118 and the 3D gesture detector 158. Information, such as text, characters, symbols, images, icons, and other items that may be displayed or rendered on a portable electronic device, is displayed on the touch-sensitive display 118 via the processor 102. The processor 102 may also interact with an accelerometer 136 that may be utilized to detect direction of gravitational forces or gravity-induced reaction forces.

To identify a subscriber for network access, the electronic device 100 may utilize a Subscriber Identity Module or a Removable User Identity Module (SIM/RUIM) card 138 for communication with a network, such as the wireless network 150. Alternatively, user identification information may be programmed into memory 110.

The electronic device 100 includes an operating system 146 and software programs, applications, or components 148 that are executed by the processor 102 and are typically stored in a persistent, updatable store such as the memory 110. Additional applications or programs may be loaded onto the electronic device 100 through the wireless network 150, the auxiliary I/O subsystem 124, the data port 126, the short-range communications subsystem 132, or any other suitable subsystem 134.

A received signal such as a text message, an e-mail message, or web page download is processed by the communication subsystem 104 and input to the processor 102. The processor 102 processes the received signal for output to the display 112 and/or to the auxiliary I/O subsystem 124. A subscriber may generate data items, for example e-mail messages, which may be transmitted over the wireless network 150 through the communication subsystem 104. For voice communications, the overall operation of the electronic device 100 is similar. The speaker 128 outputs audible information converted from electrical signals, and the microphone 130 converts audible information into electrical signals for processing.

The touch-sensitive display 118 may be any suitable touch-sensitive display, such as a capacitive, resistive, infrared, surface acoustic wave (SAW) touch-sensitive display, strain gauge, optical imaging, dispersive signal technology, acoustic pulse recognition, and so forth. A capacitive touch-sensitive display includes one or more capacitive touch sensors 114. The capacitive touch sensors may comprise any suitable material, such as indium tin oxide (ITO).

One or more touches, also known as touch contacts or touch events, may be detected by the touch-sensitive display 118. The processor 102 may determine attributes of the touch, including a location of the touch. Touch location data may include data for an area of contact or data for a single point of contact, such as a point at or near a center of the area of contact. The location of a detected touch may include x and y components, e.g., horizontal and vertical components, respectively, with respect to one's view of the touch-sensitive display 118. A touch may be detected from any suitable input member, such as a finger, thumb, appendage, or other objects, for example, a stylus, pen, or other pointer, depending on the nature of the touch-sensitive display 118. Multiple simultaneous touches may be detected.

One or more touch gestures may also be detected by the touch-sensitive display 118. A touch gesture, such as a swipe, also known as a flick, is a particular type of touch on a touch-sensitive display 118 and may begin at an origin point and continue to an end point, for example, a concluding end of the gesture. A gesture may be identified by attributes of the gesture, including the origin point, the end point, the distance travelled, the duration, the velocity, and the direction, for example. A gesture may be long or short in distance and/or duration. Two points of the gesture may be utilized to determine a direction of the gesture. A gesture may also include a hover. A hover may be a touch at a location that is generally unchanged over a period of time or is associated with the same selection item for a period of time.

The transmitters 120 and the receivers 122 of the 3D gesture detector 158 may be disposed on the touch-sensitive display 118. Alternatively, the 3D gesture detector 158 may include antennae that are operable to transmit and to receive signals. The transmitters 120 and the receivers 120 may comprise any suitable material, such as ITO. The transmitters 120 and the receivers 120 may be disposed on the same layer or layers as the capacitive touch sensors 114, disposed on another layer or layers of the touch-sensitive display 118, disposed on a cover of the touch-sensitive display 118, disposed on a housing of the electronic device 100, disposed on or included as a separate element, and so forth.

The 3D gesture detector 158 detects one or more objects that are spaced away from the electronic device 100, for example, spaced from the touch-sensitive display 118. Movement of the one or more objects may be considered a 3D gesture. A 3D gesture includes a gesture, performed by an object that is typically spaced from the touch-sensitive display 118. The object may not touch the touch-sensitive display 118. At least one of an origin, an end point, and a part of the path of the 3D gesture is spaced from the electronic device 118. The controller 156 or the processor 102 may determine attributes of the 3D gesture, such as an origin, an end, the distance travelled, the duration, the velocity, the direction, the number of objects performing the gesture, and so forth. Location data including the origin and the end may include data for a location of the object or the location of a single point on the object. The location of a detected object may include x, and y components, e.g., horizontal, vertical components, respectively, with respect to a user's view of the touch-sensitive display 118. The location may also include a z component, e.g., a component along an axis extending away from the electronic device 100, for example, an axis perpendicular to the touch-sensitive display 118, such as shown in FIG. 3. A 3D gesture may be identified by the detected attributes of the gesture. The 3D gesture may be associated with or mapped to a function that is performed. For example, a gesture may be associated with or mapped to a function utilizing a look-up table. Functions may include opening or launching an application, closing an application, proceeding to a next photo or image, reversing back to a previous image, scrolling, and zooming, to name a small number of examples.

The touch-sensitive display 118 includes a display area in which information may be displayed, and a non-display area extending around the periphery of the display area. The display area generally corresponds to the area of the display 112. Information is not displayed in the non-display area by the display, which non-display area is utilized to accommodate, for example, electronic traces or electrical connections, adhesives or other sealants, and/or protective coatings around the edges of the display area. The non-display area may be referred to as an inactive area and is not part of the physical housing or frame of the electronic device. Typically, no pixels of the display are in the non-display area, thus no image can be displayed by the display 112 in the non-display area. Optionally, a secondary display, not part of the primary display 112, may be disposed under the non-display area. Touch sensors may be disposed in the non-display area, which touch sensors may be extended from the touch sensors in the display area or may be distinct or separate touch sensors from the touch sensors in the display area. A touch, including a gesture, may be associated with the display area, the non-display area, or both areas. The touch sensors may extend across substantially the entire non-display area or may be disposed in only part of the non-display area. Transmitters and receivers may also be disposed partially or entirely within the non-display area.

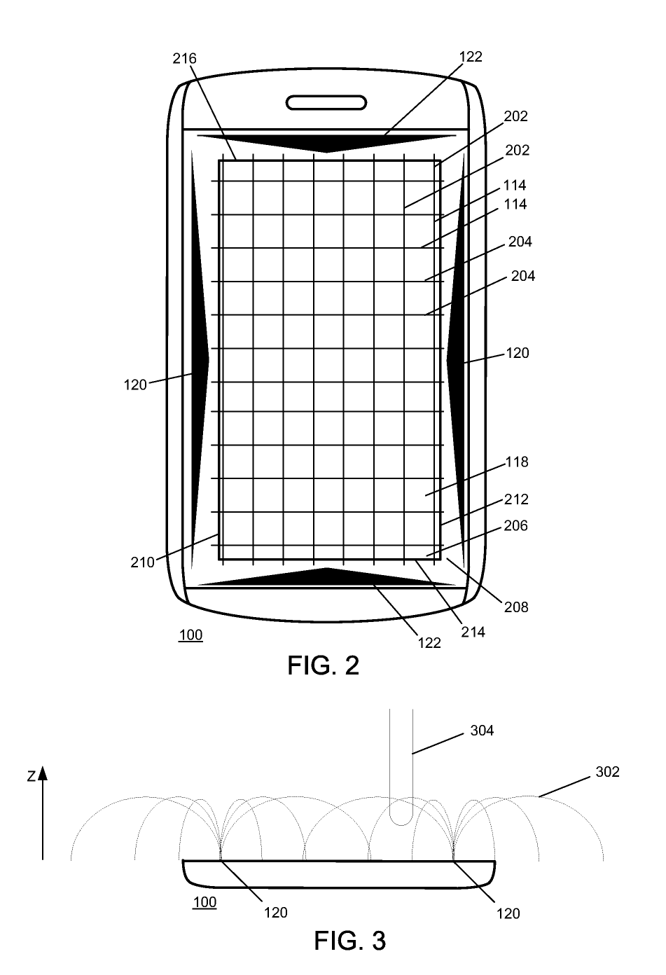

A front view of an electronic device 100 is shown in FIG. 2. Two sets of touch sensors 114, also referred to as touch-sensing electrodes, are illustrated in the example of FIG. 2. The touch sensors 114 are shown for the purpose of illustration, but are not visible to the eye when looking at the front view of the electronic device 100. Transmitters 120 and receivers 122 are also illustrated in the example of FIG. 2. As with the touch-sensors 114, the transmitters 120 and receivers 122 are shown for the purpose of illustration, but are not visible to the eye when looking at the front view of the electronic device 100.

The touch sensors 114 include drive electrodes 202 that extend generally vertically in the view illustrated in FIG. 2. The drive electrodes 202 may be disposed, for example, on a substrate, on a cover, or on any other suitable layer of the touch-sensitive display 118. The touch sensors 114 also include sense electrodes 204 that extend generally horizontally in the view illustrated in FIG. 2. The drive electrodes 202 are spaced from the sense electrodes 204 by an interlayer dielectric or insulator. The terms “vertically” and “horizontally” are utilized herein to provide reference to an orientation of the electronic device 100 in the drawings and are not otherwise limiting.

The drive electrodes 202 and the sense electrodes 204 are coupled to the controller 116 and are utilized, for example, for mutual capacitive touch sensing. The controller 116 is configured to drive the drive electrodes 202, while measuring changes in voltage across the sense electrodes 204, also referred to as receiving signals and measuring signal values from the sense electrodes 204. The change in voltage across the sense electrodes 204, or change in signal value, is a result of changes in capacitance.

In the example of FIG. 2, the electronic device 100 includes two transmitters 120 and two receivers 122 that are generally triangularly shaped. Transmitters and receivers of other shapes may be successfully implemented. The transmitters 120 are disposed in the non-display area 208, near opposite edges or sides 210, 212 of the display area 206. The receivers 122 are disposed in the non-display area 208, near opposite edges or sides 214, 216 of the display area 206. The edges or sides 214, 216 extend from the edge or side 210 to the edge or side 212.

A side view of the portable electronic device 100 is illustrated in FIG. 3. In the example of FIG. 3, signals are emitted from the transmitters 120 to generate the electric field illustrated by the dashed lines 302. The controller 156 controls the transmitters 120 and the receivers 122. Under the control of the controller 156, the transmitters 120 emit signals, for example, in the 30 to 300 kHz range such that an electric field 302 is formed by the transmitters 120. For example, the transmitters 120 may emit signals at 156 kHz. Signals of other frequencies may be successfully implemented, and the frequency utilized may depend on the controller utilized. When an object 304 is present in the electric field 302, the object 304 interferes with the electric field 302, changing the electric field 302 at the receivers 122. The charge that is induced on the receivers 122 is also affected by the object in the electric field. Thus, the receivers 122 are utilized to detect an object that is spaced from the electronic device 100, such as spaced from the touch-sensitive display 118 by measuring change in the induced charge.

An object 304 that is spaced from the electronic device 100 is detected based on changes in the induced charge on the receivers 122 when the object enters the electric field compared to the induced charge on the receivers 122 when no object is present.

3D gestures are detected based on the changes in the induced charge when the object 304 moves. When the object 304 moves relative to the receivers 122, and affects the induced charge. Thus, the induced charges on the receivers 122 changes. The changes in induced charges on the receivers 122 are measured. Movement of the object 304 is detected, for example, based on calculations utilizing the measured changes in induced charge.

Detection of 3D gestures and gestures on the touch-sensitive display 118 are detectable by the electronic device 100. The emission of signals by the transmitters 120 may cause noise that interferes with the touch sensors 114.

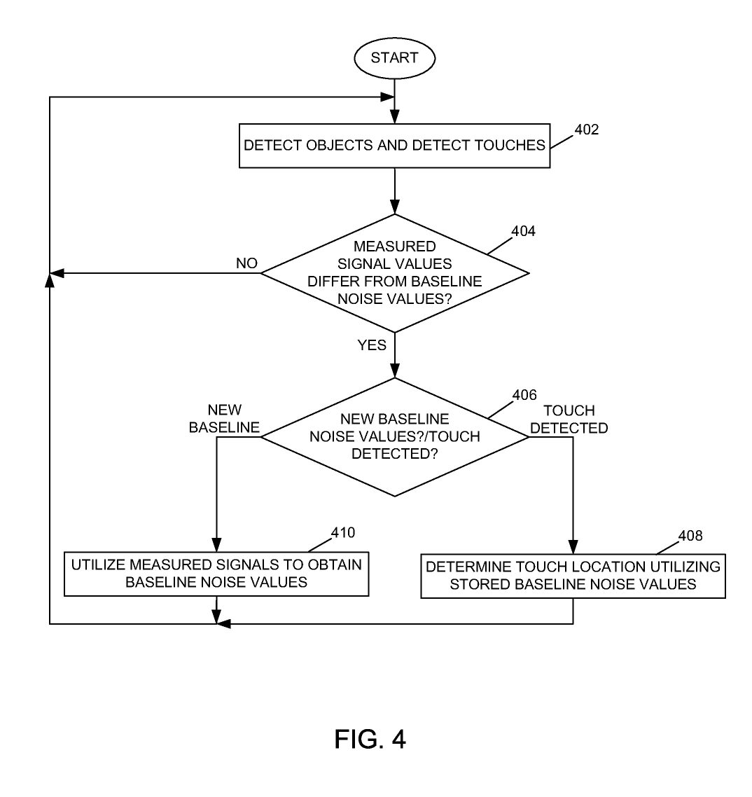

A flowchart illustrating a method of detecting touches on the touch-sensitive display 118 is illustrated in FIG. 4. The method may be carried out by software executed, for example, by the controller 116 and the processor 102. Coding of software for carrying out such a method is within the scope of a person of ordinary skill in the art given the present description. The method may contain additional or fewer processes than shown and/or described, and may be performed in a different order. Computer-readable code executable by at least one processor of the electronic device to perform the method may be stored in a computer-readable storage medium device or apparatus, which may be a non-transitory or tangible storage medium.

Utilizing the transmitters 120 and the receivers 122, an object or objects that are spaced from the electronic device 100, such as spaced from the touch-sensitive display 118, are detected 402. When a gesture is identified, the associated function is identified.

Touches on the touch-sensitive display 118 are detected 402 by driving the drive electrodes 202 while receiving signals from sense electrodes 204. Signal values from the sense electrodes 204 are determined and are compared 404 to baseline noise values. When one or more of the signal values differs from a baseline noise value by a threshold amount, the process continues at 406. The threshold amount is selected or determined such that most noise, e.g., 85%, 90%, 95%, 99%, or other percentage, is below or under the threshold amount. The threshold amount may be, for example, a threshold of 0.5 volts or more. The baseline noise values may be values associated with nodes of the touch-sensitive display when no touch is detected.

A touch is detected when a significant reduction in at least one measured signal value, as compared to the baseline noise value, is detected. A significant reduction in at least one measured signal value may be a reduction that meets a threshold value. Thus, when a measured voltage across a sense electrode 204 is reduced by a threshold amount, a touch is detected. For example, a threshold of 2.5 volts may be utilized such that a touch is detected when the signal value is reduced by 2.5 volts or more when the drive electrode is driven by a 3.3 volt source. Other threshold values may be successfully implemented. When a touch is detected 406 based on the difference between the signal values and the baseline noise values, the touch location is determined 408 by applying the baseline noise values to the signal values. The baseline noise values may be applied to the signal values by subtracting the baseline noise values from the signal values, comparing the baseline noise values to the signal values, or providing any other suitable evaluation or calculation between the baseline noise values and the signal values. An associated function may be identified. The function is identified based on the touch attributes, including the touch location.

When the baseline noise values differ from the determined signal values and no touch is detected 406, the signal values are utilized 410 to obtain new baseline noise values. The signal values may be stored for use as the baseline noise values when a further touch is detected. When the signal values differ from baseline noise values and a touch is not detected, the difference may be identified as a difference due to a change in the operating environment, and the signal values are utilized as the new baseline noise values. Alternatively, the baseline noise values may be adjusted based on the determined signal values and based on previous baseline noise values such that the new baseline noise values are calculated utilizing both the previous baseline noise values and the determined signal values. The calculation of the new baseline noise values may also be based on other factors, such as historical baseline noise values and user preferences. When no touch is detected by the touch sensors 114 and the transmitters are transmitting, the signal values may be stored for use as baseline values when a touch is detected while the transmitters 120 are transmitting. These baseline values may be utilized to compensate for noise caused by the transmitters 120. When no touch is detected by the touch sensors 114 and the transmitters 120 are not transmitting, the signal values may be stored for use as baseline values when a touch is detected while the transmitters are not transmitting. These baseline values may be utilized to compensate for noise caused by one or more sources other than the transmitters 120. Thus, two different baseline values may be stored and utilized in different situations. The noise imparted on the touch sensors 114 may be different when the transmitters 120 are transmitting than when the transmitters 120 are not transmitting, thus different baseline values may be applied depending on whether the transmitters 120 are transmitting or not.

When a touch is detected after obtaining the new baseline noise values, the touch location is determined by applying the new baseline noise values to the determined signal values to reduce the effect of noise created by the transmitters on the detected signal values.

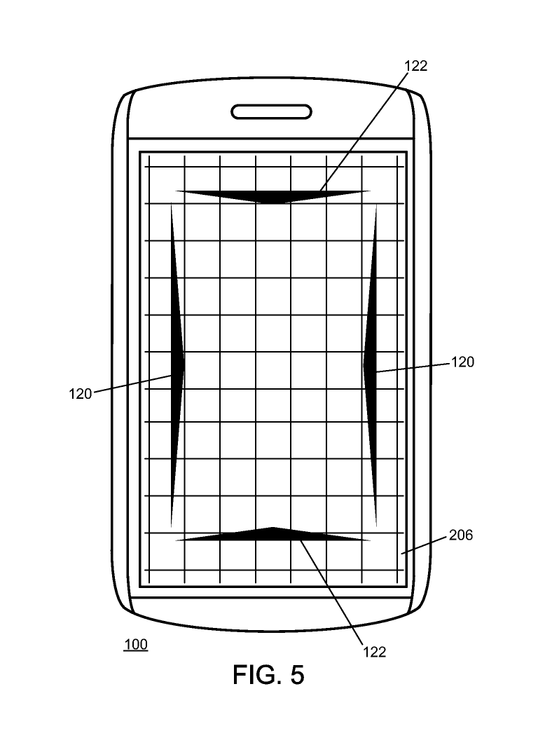

A front view of another portable electronic device 100 is shown in FIG. 5. In the example of FIG. 5, the transmitters 120 and receivers 122 are disposed in the display area 206. As indicated above, the transmitters and the receivers may be any other suitable shape. Other numbers of transmitters and receivers may also be successfully implemented. For example, the electronic device may include an array of transmitters and receivers. When the baseline noise values differ from the determined signal values and no touch is detected, a difference between the baseline noise values and the signal values may be determined. The signal values may be utilized to obtain the baseline noise values when the difference meets a threshold. Alternatively, the signal values may be utilized, when no difference between the signal values and the baseline noise values is determined. Such signal values may be utilized, for example, to determine an average of signal values, such as an average of a predetermined number of signal values.

When one or more of the signal values from touch sensors of the touch-sensitive display differ from a baseline noise value or values by a threshold amount and no touch is detected, the signal values are utilized as baseline noise values to detect further touches. The baseline noise values may be adjusted dynamically to reduce noise caused by interference of transmitters with the touch sensors of the touch-sensitive display. Thus, the baseline noise values are adjusted when changes in measured values occur and no touch is detected.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

What is claimed is:

1. A method comprising:
utilizing transmitters and receivers in an electronic device to detect at least one object spaced from a touch-sensitive display of the electronic device;
determining first signal values utilizing touch sensors of the touch-sensitive display to obtain baseline noise values when no touch is detected and the transmitters are transmitting;
when a touch is detected, applying the baseline noise values to second signal values to reduce the effect of noise when identifying the touch location.

2. The method according to claim 1, comprising utilizing the second signal values to obtain second baseline noise values when no touch is detected.

3. The method according to claim 1, wherein, the baseline noise values are obtained in response to determining a difference between the first signal values when no touch is detected and previous baseline noise values.

4. The method according to claim 1, wherein the touch location is identified based on a difference between the second measured signal values and the baseline noise values.

5. The method according to claim 1, wherein the touch is detected based on a determined change in signal value associated with a node of the touch-sensitive display.

6. The method according to claim 1, wherein when the touch is detected, the baseline noise values are maintained.

7. The method according to claim 1, wherein when no touch is detected the second signal values are utilized to obtain second baseline noise values to identify touch locations of further touches.

8. The method according to claim 1, comprising detecting new signal values and, when no touch is detected and the new signal values differ from the baseline noise values by a threshold amount, utilizing the new signal values to obtain second baseline noise values.

9. The method according to claim 1, wherein the transmitters emit signals to form a low-frequency electric field between the transmitters and the receivers.

10. The method according to claim 1, wherein detecting first signal values comprises measuring changes in charge induced on the receivers.

11. A computer-readable storage device having computer-readable code stored thereon, the computer-readable code executable by at least one processor of the electronic device to perform the method of claim 1.

12. An electronic device comprising:
a touch-sensitive display including touch sensors arranged and constructed to determine first signal values to obtain baseline noise values when no touch is detected on the touch-sensitive display;
transmitters and receivers arranged and constructed to detect at least one object spaced from the touch-sensitive display;
wherein, when a touch is detected, the baseline noise values are applied to second signal values to reduce the effect of noise when identifying the touch location.

13. The electronic device according to claim 12, wherein, the baseline noise values are obtained in response to determining that a difference between the first signal values when no touch is detected and previous baseline noise values meets a threshold.

14. The electronic device according to claim 13, wherein the baseline noise values are applied to detect further touches and identify associated touch locations.

15. The electronic device according to claim 13, wherein a touch is detected based on a difference between the second signal values and the baseline noise values.

16. The electronic device according to claim 13, wherein the touch-sensitive display comprises drive electrodes and sense electrodes and a touch is detected based on a change in signal value at a node of the touch-sensitive display.

17. The electronic device according to claim 13, wherein the baseline noise values are maintained when the touch is detected.

18. The electronic device according to claim 13, wherein the transmitters emit signals to form a low-frequency electric field between the transmitters and the receivers.

19. The electronic device according to claim 13, wherein determining signal values comprises determining changes in charge induced on the receivers.

20. A method comprising:
utilizing transmitters and receivers of an electronic device to detect at least one object spaced from the electronic device;
when the transmitters are transmitting, determining first signal values utilizing touch sensors of the touch-sensitive display to obtain first baseline noise values when no touch is detected by the touch sensors;
when the transmitters are transmitting, detecting a touch while determining second signal values utilizing the touch sensors, and applying the first baseline noise values to the second signal values to reduce the effect of noise created by the transmitters on the second signal values when identifying a touch location;
when no touch is detected based on the second signal values and the transmitters are not transmitting, utilizing the second signal values to obtain second baseline noise values;
when the transmitters are not transmitting, detecting a touch while determining third signal values utilizing the touch sensors, and applying the second baseline noise values to the third signal values to reduce the effect of noise created by at least one source other than the transmitters on the third signal values when identifying a touch location.
